(19) United States
(12) Patent Application Publication
(10) Pub. No.: US 2005/0137940 A1
(43) Pub. Date: Jun. 23, 2005

(54) Method to provide a product to a consumer to protect consumer privacy

(76) Inventor: Jeffrey D. Lindsay, Appleton, WI (US)

Correspondence Address: KIMBERLY-CLARK WORLDWIDE, INC., 401 NORTH LAKE STREET, NEENAH, WI, 54956, US

(21) Appl. No.: 10/744,146

(22) Filed: Dec. 22, 2003

(51) Int. Cl. G06F 17/60

(52) U.S. Cl. 705/26

(57) ABSTRACT

A method of providing a product to a consumer in which an identity of the product is concealed is disclosed. The method can be useful when a consumer wishes to prevent others from knowing the identity of a product being purchased or otherwise obtained. In particular embodiments of the method, a request is received from the consumer to purchase a product. A disguising packaging material in which to package the requested product is selected. The requested product is packaged with the disguising packaging material to create a custom packaged product. The custom packaged product is provided to the consumer. The customer is billed for the custom packaged product. In certain embodiments, the custom packaged product includes one or more signalers which are scanned to determine information pertaining to the requested product.

### BACKGROUND OF THE INVENTION

Many consumers are uncomfortable or embarrassed purchasing certain products from a public retail outlet. For example, incontinence products, feminine care products, absorbent underpants for youths suffering from enuresis, contraceptives, various medications, and other healthcare products often bring embarrassment to the user if others note that the product is being purchased. Consumers may be reluctant to physically remove the product from a store shelf, may be embarrassed to audibly ask a store attendant for a particular product, and may be embarrassed if the product is identified on an electronic display during checkout. In certain situations, the user may want the nature of the product to remain concealed even after purchase. For example, a child with a bedwetting problem may be embarrassed if friends or visitors see disposable absorbent underpants in the child's room. Consumers may also want to conceal the nature of a product they are purchasing for other reasons, such as when buying a gift for someone accompanying them to a store. Therefore, a method of providing products to consumers in a discreet and inconspicuous fashion is needed.

### SUMMARY OF THE INVENTION

In one embodiment, the method of the present invention includes providing a product to a consumer. The embodiment includes electronically receiving a request from the consumer to purchase the product; presenting the consumer with a plurality of choices of disguising packaging materials in which to package the product; receiving a selection from the consumer for a selected disguising packaging material from among the plurality of choices; packaging the product with the selected disguising packaging material to create a custom packaged product; providing the custom packaged product to the consumer; and billing the consumer for the custom packaged product.

In another embodiment, the method of the present invention includes providing a product to a consumer in which an identity of the product is concealed. The embodiment includes receiving a request from the consumer to purchase the product; presenting the consumer with a plurality of choices of disguising packaging materials in which to package the product; receiving a selection from the consumer for a selected disguising packaging material from among the plurality of choices; packaging the product with the selected disguising packaging material to create a custom packaged product; providing the custom packaged product to the consumer; scanning the custom packaged product to determine the identity and a price of the requested product; and billing the consumer for the custom packaged product.

In yet another embodiment, the method of the present invention includes providing a product to a consumer in which an identity of the product is concealed. The embodiment includes receiving a request from the consumer to purchase the product; presenting the consumer with a plurality of choices of disguising packaging materials in which to package the product; receiving a selection from the consumer for a selected disguising packaging material from among the plurality of choices; scanning the requested product to determine the identity and a price of the requested product; packaging the product with the selected disguising packaging material to create a custom packaged product; providing the custom packaged product to the consumer; scanning the custom packaged product to determine the identity, the price, and the discreet status of the requested product; and billing the consumer for the custom packaged product.

In still another embodiment, the method of the present invention includes providing a product to a consumer in which an identity of the product is concealed. The embodiment includes receiving a request from the consumer to purchase the product; selecting a disguising packaging material for the consumer; packaging the product with the disguising packaging material to create a custom packaged product; providing the custom packaged product to the consumer; scanning the custom packaged product to determine the identity of the requested product; and billing the consumer for the custom packaged product.

### BRIEF DESCRIPTION OF THE DRAWINGS

FIG. 1 representatively shows an electronic input device suitable for use in particular embodiments of the method of the present invention.

FIG. 2 representatively shows a product being packaged according to particular embodiments of the method of the present invention.

FIG. 3 representatively shows a check-out counter, scanner, display medium, and custom packaged product according to particular embodiments of the method of the present invention, with portions cut away to show underlying features.

### DETAILED DESCRIPTION OF THE INVENTION

The present invention relates to a method of providing a product to a consumer. The method can be particularly effective in providing a product to a consumer in a discreet and inconspicuous manner. Consumers may be embarrassed to purchase certain products in public view, and the present method can provide a mechanism by which to reduce or eliminate such embarrassment. Examples of products that consumers may be embarrassed to purchase in public view include disposable absorbent articles adapted to absorb bodily fluids, such as incontinence products, feminine care products, training pants, and absorbent underpants for youths suffering from enuresis. Additional examples of products that consumers may be embarrassed to publicly purchase include contraceptives and certain medications. A consumer may wish to disguise the identity or price of a product for other reasons as well. For example, a consumer may wish to disguise the identity and/or cost of an expensive item, such as jewelry, as a less expensive item, such as a boxed video cassette or a container of food, to reduce the risk of theft. In another example, an individual may wish to disguise the identity of a product from someone accompanying them in a store, such as when the individual desires to purchase a surprise gift for the person accompanying the purchaser.

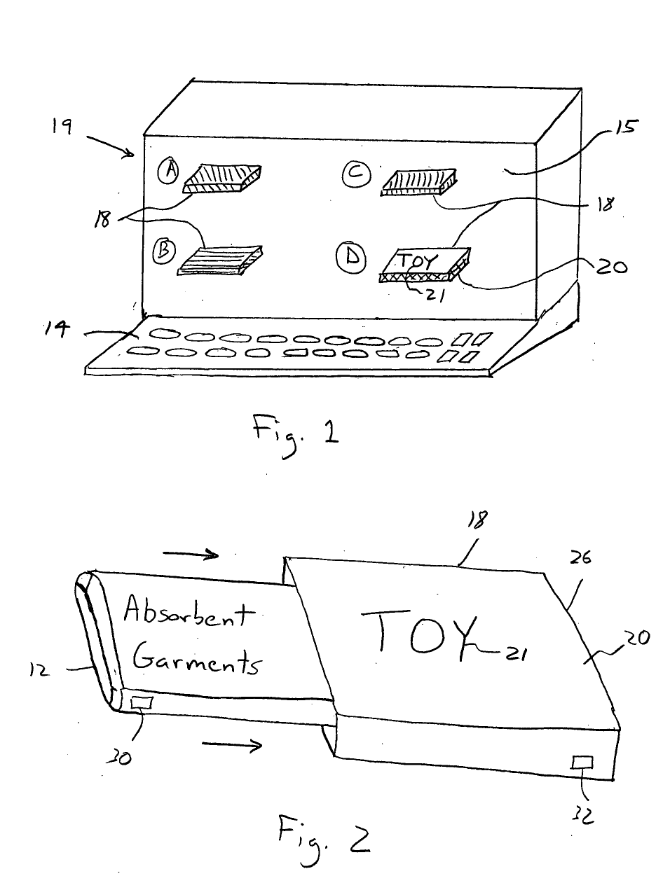

Referring generally to FIGS. 1-3, the method of the present invention includes, in particular embodiments, receiving a request from a consumer to purchase a product 12. The request can be received verbally, such as over the telephone or in-person within a store. The request can be received in writing; for example, a consumer can enter information on a paper form, and submit it to store personnel. To minimize the conspicuousness of the request, the request is presently preferably received electronically. For example, the request can be received via the Internet using a program designed to present various product options and to accept a request for a product or products. The request can be made via a wireless device, such as a hand-held personal digital assistant (PDA), or via a cellphone by way of entering numbers in response to a preprogrammed menu of product options. In particular embodiments, the request for the product is made via an electronic device, such as an input device 14, located with the store premises of the retail store in which the product is publicly available for sale. “Store premises” as used herein means the store building, as well as areas connected with the use of the store by a consumer, such as a store parking lot. The electronic device may be wired to a network utilized by the store, or it may be wireless. The devices are in electronic communication with a computer processor (not shown) which receives the request as part of particular embodiments of the method of the present invention. As examples, the electronic device can be located at the store entrance; in a store aisle; or at a store pharmacy counter. In one desirable embodiment, the electronic device is a wireless device located on a shopping cart. In other embodiments, the electronic device is an interactive computer located on the store premises.

In yet another embodiment, the request can be made via a customer identification device. “Customer identification device” as used herein means a device, readable by a sensor, adapted to convey information about a customer, such as, for example, the customer's name, the customer's purchase history at the store, and the customer's purchase preferences such as periodic recurring product requests. Such devices can include, by way of example, bar codes, magnetic strips, or radio frequency identification (“RFID”) tags disposed on or within plastic cards or other suitable structure. In particular embodiments, the customer identification device is read by a sensor, and a request for product is automatically placed and received according to previous instructions submitted by the consumer, such as instructions to request purchase of a fixed amount of the product each time the consumer enters the store or at a recurring point each week, month, year, or other time period. In certain embodiments, the request for the product is fulfilled only after the consumer has verified and/or modified the order following reading by the sensor. For example, a consumer can configure a consumer profile page on the Internet to indicate that the consumer wishes to purchase a fixed number of a particular brand and code of incontinence garments each month. Upon entering the store, the consumer's customer identification device can be read by the appropriate sensor, and the consumer's previous instructions are compared to the consumer's recent purchase history to determine if the consumer may wish to purchase the incontinence garment product during the present visit. In certain embodiments, a display device can ask the consumer to confirm or modify the proposed purchase of the product. The receiving and processing of this information can, in certain embodiments, be performed by a computer processor (not shown).

In particular embodiments, the method of the present invention also includes packaging the product with a disguising packaging material 18, such that the identity of the product is concealed to prevent possible embarrassment associated with the purchase of certain products. In certain embodiments, the method includes presenting the consumer with a plurality of choices 19 of disguising packaging materials in which to package the product. The specific type of disguising packaging material 18 preferably is suitable to conceal the identity of the product, and can include, by way of example, materials such as paper, cardboard, plastic, and metal foil. “Conceal” as used herein means to make it difficult or impossible to determine the contents of the packaged product upon ordinary visual inspection.

In one embodiment, representatively illustrated in FIG. 1, the plurality of choices of disguising packaging materials is displayed to the consumer by way of a display screen 15, which is representatively illustrated as including an input device 14. For example, a variety of boxes, bags, wrappers, or other packaging materials can be displayed on a computer monitor after the product request has been received. In other embodiments, the packaging materials 18 can be displayed on an input device 14/display screen 15 before the product request has been received. The input device 14/display screen 15, such as a computer monitor, can be but need not be located on the store premises. All of the choices can be displayed at once, or only a portion of the choices can be displayed at one time. In the latter instance, the computer or other device can be equipped with a mechanism to allow a consumer to “scroll” to a succeeding group or groups of choices. In another embodiment, actual physical samples of one or more of the plurality of disguising packaging materials can be displayed to the consumer, or depictions of the packaging materials other than on a computer monitor can be displayed.

The plurality of disguising packaging materials can include any variety of colors, patterns, designs, textures, or configuration. In one desirable embodiment, the plurality of choices of packaging materials includes at least one packaging configuration 20 associated with a product other than the requested product. Such a packaging configuration 20 can be a particularly effective disguise for the requested product, leading individuals viewing the product to assume that the requested product, once packaged in such a packaging material, is actually the other product. For example, the plurality of choices 19 of packaging materials 18 could include at least one packaging material resembling a packaging material 20 for a popular children's toy or video game. In certain embodiments, the plurality of choices 19 of packaging materials 18 includes only packaging materials resembling packaging materials for products other than the requested product.

In some embodiments, the disguising packaging material 18 is printed with indicia 21 to simulate the printed packaging of a product other than the requested product, such as a commercially available product or a fictitious product pertaining to a different product category, such as electronic games, kitchenware, or clothing. The indicia 21 can include logos and associated graphics, text, barcodes, and the like. In one embodiment, the disguising packaging material 18 comprises a printed cardboard, corrugate, plastic, metal, or other relatively rigid container, in contrast to relatively flexible materials such as paper or plastic film. In particular embodiments, the disguising packaging material 18 comprises a rigid material such that the disguising packaging material 18 is capable of substantially maintaining a predetermined shape under a compressive load of about 2 pounds (applied by a 5-inch square metal plate placed on top of and approximately in the center of the disguising packaging material 18 prior to filling).

In particular embodiments, the method of the present invention also includes receiving a selection from a consumer for a selected disguising packaging material 18. In particular embodiments, the selection is made from among a presented plurality of choices 19 of disguising packaging materials 18. The selection can be received verbally, such as over the telephone or in-person within a store. The selection could be received in writing; for example, a consumer can enter information on a paper form indicating his selection, and submit it to store personnel. In another embodiment, the selection is received electronically. For example, the selection can be received via the Internet using a program designed to present various packaging material options and to accept a selection for a particular packaging material. The selection can be made via a wireless device, such as a hand-held personal digital device, or via a cell phone by way of entering numbers in response to a preprogrammed menu of options of packaging materials. In particular embodiments, the selection for a disguising packaging material is made via an electronic device, such as an input device 14 (FIG. 1), located within the store premises of the retail store in which the requested product is publicly available for sale and in which the packaging materials are located. The electronic device may be wired to an internal network, or it may be wireless. The devices are in electronic communication with a computer processor which receives the selection as part of particular embodiments of the method of the present invention. As examples, the electronic device may be located at the store entrance; in a store aisle; or at a store pharmacy counter. In one desirable embodiment, the electronic device is a wireless device located on a shopping cart. In other embodiments, the electronic device may be an interactive computer located on the store premises. In still another embodiment, the selection can be made via a customer identification device. For example, when a customer identification device is read by a sensor, a particular packaging material can be selected in conjunction with a request for product according to previous instructions submitted by the consumer, such as instructions to request purchase of a fixed amount of the product each week or month, and to packaging the product in a particular disguising packaging material, or in an organized or random sequence of disguising packaging materials. In the event the selection is received electronically, the selection can, in certain embodiments, be received by a computer processor (not shown), programmed to act upon the received selection, such as generating a command to package the requested product in the selected packaging material.

In one embodiment, the method of the present invention includes selecting a disguising packaging material for the consumer. One advantage to embodiments having this feature is that a consumer who desires disguising packaging for her requested product, but does not wish to expend the time selecting a disguising packaging material, can allow a different decision maker to select a disguising packaging material for her. For example, after a request has been received for a product from a consumer, a disguising packaging material can be selected for the consumer. In a different embodiment, a disguising packaging material can be selected for the consumer prior to receiving the product request. In other words, a disguising packaging material or group of disguising packaging materials can be identified beforehand as appropriate to disguise a package to prevent disclosure of a product's identity. In either embodiment, the selection can be made, for example, by a human being, such as a store employee, or by a computer according to preprogrammed instructions.

In particular embodiments, the method of the present invention includes producing the selected packaging material following the step of receiving a selection from the consumer for a selected packaging material. “Producing” as used herein with respect to packaging material refers to adding aesthetic or identification components to an underlying raw material, and/or to sizing, shaping, or otherwise configuring a starting raw material to render it suitable for use as a disguising packaging material for a requested product. Examples of aesthetic components include (without being limiting) graphics, stickers, embossing, and perforations. Examples of identification components include (without being limiting) barcodes, magnetic strips, holographic elements, electrochromic graphical display panels, and radio frequency identification tags. “Producing” as used herein does not refer to the manufacture of starting raw materials, such as the manufacture of paper from wood pulp, the manufacture of an ink, or the extrusion or casting of a plastic film or structure.

In particular embodiments, producing the selected packaging material includes printing graphics on a substrate. For example, in one embodiment, after a consumer has selected a particular packaging material and that selection has been received, a computer processor can generate a command to print particular graphics on packaging paper or plastic. The particular graphics would correspond to the received selection. The printing can be done by any suitable printing mechanism (not shown), such as, for example, a color laser printer or an ink jet printer In one embodiment, the graphics, as previously discussed, can cause the selected packaging to resemble the packaging of a product, such as popular children's toy, other than the original packaging of the requested product. In particular embodiments, producing the selected packaging material includes adding an identification component, such as a bar code or radio frequency identification tag. Such an identification component can, in certain embodiments, function as a secondary signaler, explained below. One example of a printer suitable to produce selected disguising packaging materials in accord with the method of the present invention is a Xaar XJ500 printhead available from Xaar PLC of Cambridge, England.

After the product has been requested and a disguising packaging material has been selected, the method of the present invention includes, as representatively illustrated in FIG. 2, packaging the product with the selected disguising packaging material to create a custom packaged product 26. The packaging may be done by hand or by automated equipment. Examples of automated packaging equipment include an automated shrink wrapper, an automated boxer, an automated case packer, and an automated bagger, all of which are known in the packaging equipment art. In one embodiment, the packaging is conducted in a non-public area or room within the store premises. In particular embodiments, a non-public area of the store contains a supply of commonly requested products for which consumers may desire disguised packaging, such as incontinence or enuresis garments. The product request and the packaging material selection are communicated to personnel (or to automated equipment) located in the non-public area of the store, and the requested product 12 is then packaged in the selected packaging material 18. If the requested product includes original packaging of its own, the requested product can remain in its original packaging, and be further packaged in the selected disguising packaging material 18. Alternatively, the contents of the requested packaged product can be removed from its original packaging, and then packaged in the selected disguising packaging material.

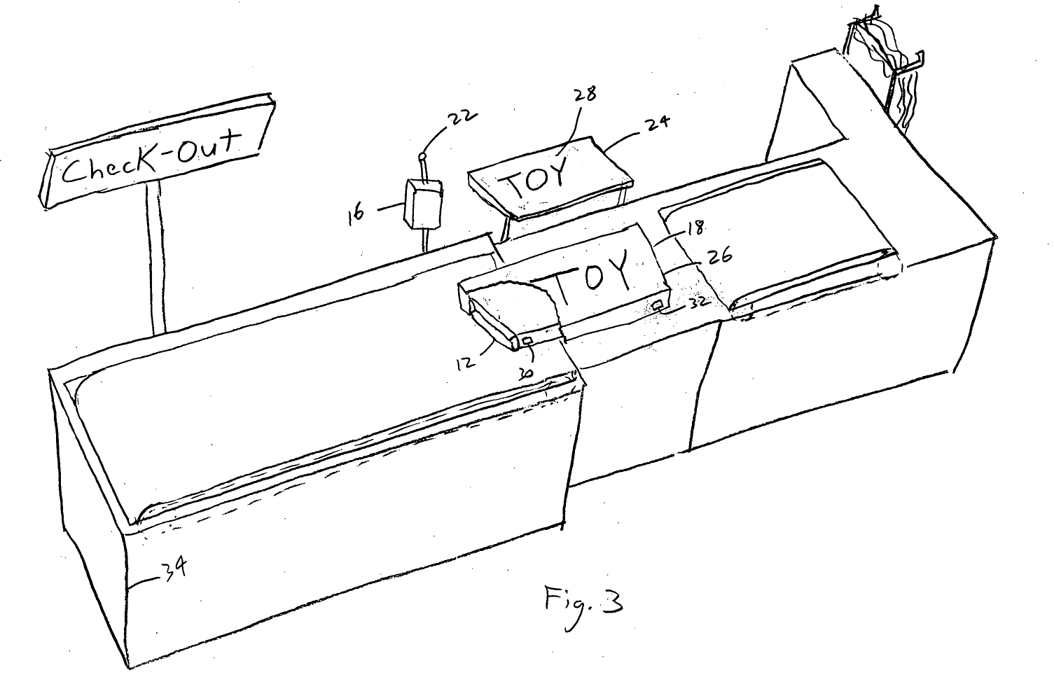

Referring to FIGS. 2 and 3, in particular embodiments of the method of the present invention, the custom packaged product 26 described above can include a primary signaler 30, a secondary signaler 32, or both. “Primary signaler” refers to a component, disposed on or within a requested product, constructed to convey information about the product when sensed by a compatible sensor. “Secondary signaler” refers to a component, disposed on or within a custom packaged product, constructed to convey information about the custom packaged product and/or the requested product packaged therein when sensed by a compatible sensor. “Convey” as used with respect to signalers means that the signaler can provide information either directly (data of interest is contained, written, printed, programmed, or otherwise included or stored within or upon the signaler itself), or indirectly (at least some data of interest is contained, written, printed, programmed, or otherwise included or stored within or upon a data storage source other than the signaler which can be accessed using information from the signaler). An example of a signaler constructed to directly provide information is a read-write RFID which has written thereon specific information about a product, such as identity or price information, and communicates that information when sensed by a suitable sensor, as will be described shortly. An example of a signaler constructed to indirectly provide information is a read-only RFID tag that, when sensed, communicates limited information, such as a product identity (e.g., a unique electronic product code or categorical identifier), and that product identity is thereafter linked with additional information, such as the product price, stored elsewhere, such as in an electronic database.

Examples of primary signalers include bar codes, radio frequency identification tags, magnetic strips, compressed symbology markings (two-dimensional identification marks) such as, for example, the DataMatrix™ system of RVSI Acuity CiMatrix (Canton, Mass.), and alphanumeric text. In particular embodiments, the primary signaler 30 and the secondary signaler 32 are radio frequency identification tags. In one embodiment, a primary signaler 30 is disposed on or within the requested product by the manufacturer of the requested product. In another embodiment, the primary signaler 30 is disposed on or within the requested product by the manufacturer of the requested product's original packaging, such as a bag manufacturer if the requested product's original package is a bag.

Similarly, examples of secondary signalers include bar codes, radio frequency identification tags, compressed symbology markings, magnetic strips, and alphanumeric text. In particular embodiments, a secondary signaler 32 is a bar code disposed on the custom packaged product. In one embodiment, the secondary signaler appears on or within a label which can be affixed to the custom packaged product. For example, during packaging of the requested product in the selected disguising packaging material, a bar code label or a radio frequency identification tag can be disposed on or within the custom packaged product, such as by printing onto the disguising packaging material or applying an adhesive label with a barcode printed thereon. In another embodiment, the secondary signaler 32 is integral with the selected disguising packaging material. For example, in an embodiment in which the selected disguising packaging material is produced (following its selection by a consumer) by printing a substrate within the store premises, a bar code label and the disguising graphics can be printed onto the substrate in a single operation. In other embodiments, a barcode or an RFID tag is affixed to a pre-printed disguising packaging material 18 (or otherwise disposed on or within the disguising packaging material 18) within the store premises.

The secondary signaler 32 can be created within the store premises, or be supplied to the store premises already created. In a desirable embodiment, the secondary signaler 32 is created within the store premises following receipt of a product request and receipt of a disguising packaging material selection. For example, an electronically received product request and an electronically received disguising packaging material selection can be processed by a computer processor, and the computer processor can subsequently generate a command (directed, for example, to either a store employee or an automated packaging unit) to package the requested product in the selected disguising packaging material to create a custom packaged product and to dispose thereon a secondary signaler, such as a bar code label or a radio frequency identification tag.

In particular embodiments, the primary signaler 30, the secondary signaler 32, or both, are constructed to convey information about the requested product 12 when sensed by a compatible sensor. For example, the primary signaler can be constructed to convey information pertaining to the requested product's identity, price, or both. The primary signaler can also be constructed to convey information pertaining to a requested product's discreet status. “Discreet status” as used herein to describe a product means that a consumer has requested that the product be packaged in disguising packaging material, such as to prevent embarrassment that the consumer fears would result if the product were not disguised during purchase or transport. In another example, the secondary signaler can be constructed to convey information pertaining to requested product's identity, price, or both. The secondary signaler can also be constructed to convey information pertaining to a requested product's discreet status.

In one embodiment, after a consumer requests a product and selects a disguising packaging material, a secondary signaler is created and disposed on, disposed within, or made integral with the selected packaging material. In this case, the secondary signaler can be constructed to convey a discreet status of the requested product. In another embodiment, the method of the present invention includes scanning the requested product prior to or during packaging of the requested product within the selected disguising packaging material. In this scanning step, an identification component (such as a primary signaler) disposed within or upon the requested product can convey, for example, identity or price information about the requested product to a computer processor. The computer processor, in turn, can convey the identity or price information to a device that constructs secondary signalers, such as a bar code labeler, a radio frequency identification tag labeler, an RFID writer for read-write tags, or a laser printer which prints disguising packaging material. “Scanning” as used herein means to examine an identification component, such as a bar code, a magnetic strip, or a radio frequency identification tag, with a suitable sensor to detect information.

It should be noted that certain signaling components, such as a primary signaler 30 or a secondary signaler 32, can be modified electronically, such as, for example, by “writing” new information to an existing read-write RFID tag. In certain embodiments, a pre-provided secondary signaler 32, such as an RFID tag, can be disposed within or upon a disguising packaging material before the disguising packaging material arrives at the store location. In such an embodiment, the pre-provided read-write RFID tag can be “written” with information relating to a custom packaged product, avoiding the need for a store to acquire RFID tags separate from and in addition to obtaining disguising packaging material.

The method of the present invention includes providing the custom packaged product 26 to a consumer. The custom packaged product can be provided to a consumer at any suitable location in the store, such as at a pharmacy counter, a checkout area, a customer service desk, a kiosk in or near the store or otherwise cooperatively associated with the store, or other designated dispensing location for custom packaged products. Alternatively, the custom packaged product can be placed in the shopping cart of the consumer by an employee at any point during the consumer's visit to the store premises, such as in the store building or in the parking lot at a location near the consumer's vehicle.

Referring to FIG. 3, the method of the present invention includes, in particular embodiments, scanning the custom packaged product to detect information about the requested product. That is, after the requested product has been packaged in a disguising packaging material to create a custom packaged product, the custom packaged product can be scanned to detect information, such as, for example, the price or identity of the requested product, or the discreet nature of the requested product. The scanning can be performed by a scanner 16, such as at a check-out counter 34. While the RFID scanner 16 is portrayed as a single unit, it is recognized that the RFID scanner 16 can comprise a plurality of physically separated but cooperatively associated electronic devices that are not shown independently such as a radio frequency signal generator, a radio frequency signal receiver, and a processor.

In particular embodiments, a primary signaler 30, a secondary signaler 32, or both a primary and a secondary signaler are scanned. For example, a primary signaler 30 can be scanned to detect the requested product's identity, price, or discreet status, or a combination thereof. In another example, a secondary signaler 32 can be scanned to detect the requested product's identity, price, or discreet status, or a combination thereof. In yet another example, both a primary signaler 30 and a secondary signaler 32 are scanned to detect the requested product's identity, price, or discreet status, or some combination thereof. Furthermore, if both a primary signaler and a secondary signaler are included in the custom packaged product and are both scanned, different information can be detected from them, respectively. For example, a primary signaler 30 can be scanned to detect the identity and price of the requested product, and a secondary signaler 32 can be scanned to detect the requested product's discreet status. In such an embodiment, the primary signaler can but need not be a radio frequency identification tag. This can allow the primary signaler to be sensed even if it is physically covered with a disguising packaging material.

In particular embodiments of the method of the present invention, scanning the custom packaged product causes a description 28 to be displayed on a display medium. In certain embodiments, the description 28 is adapted to conceal the identity of the requested product. For example, when the custom packaged product is scanned, a displayed description can be generic in nature, such as “item,” “product,” “article,” “personal care article,” or other general description. Furthermore, a disguising price can be displayed, or no price can be displayed. “Disguising price” means a price different than the price of the requested product. In another example, if the selected disguising packaging material comprises a packaging configuration associated with a product other than the requested product, the displayed description can describe the other product. For instance, if the selected disguising packaging material is associated with a popular children's toy, the displayed description can identify that popular children's toy. In such an embodiment, the displayed description can, but need not, also include a disguising price. The disguising price can be the price of the popular children's toy, or no price can be displayed.

The display medium can take any number of configurations. By way of example, the display medium can be an electronic display medium, such as a computer monitor, an LED display, or an audio speaker, or combinations thereof. In one desirable embodiment, the display medium is a flat-panel display monitor 24. The display medium, such as a flat-panel display monitor 24, can be configured to accommodate consumers having visual impairment, language difficulties, illiteracy, and the like. For example, the display monitor can convey information in different languages, or pictorially, or can emit voice messages in selected foreign languages. Alternatively, the display medium can be a paper receipt, such as a printed paper receipt. Although it is generally desirable that the description not directly identify the identity of the requested product (to preserve the consumer's privacy and to prevent possible embarrassment), it can be desirable in certain embodiments to cause a description to appear that does identify the identity of the requested product, such as a supplemental description. For example, on a printed paper receipt or statement in which a generic, disguising description appears in a list of items purchased during a consumer's particular visit to a store, a supplemental description can appear on the printed paper receipt or statement, such as at the bottom, and identify the identity of the requested product. Preferably, such a supplemental description is inconspicuous.

The description 28 can be provoked in a variety of ways. For example, the description 28 can be provoked by sensing the primary signaler 30 and detecting information about the requested product. Alternatively, the description can be provoked by sensing the secondary signaler 32 and detecting information about the requested product. In one embodiment, a secondary signaler 32 is adapted to convey information about the requested product's identity, price, and discreet status, and the secondary signaler is scanned to detect this information. The information is relayed to a computer processor (not shown) having preprogrammed instructions. Having detected a discreet status, the computer processor causes a disguising description to be displayed, omitting, for example, the identity of the requested product, the price of the requested product, or both.

In another embodiment, a primary signaler 30, such as a radio frequency identification tag, is adapted to convey information about the requested product's identity and price, and the primary signaler is scanned to detect this information. This information is relayed to a computer processor having preprogrammed instructions. Moreover, a secondary signaler 32, such as a radio frequency identification tag, is adapted to convey information about the requested product's discreet status, and the secondary signaler is scanned to detect this information. This information is also relayed to the computer processor having preprogrammed instructions. The computer processor, having detected a discreet status by virtue of sensing the secondary signaler, causes a disguising description to be displayed, omitting, for example, the identity of the requested product, the price of the requested product, or both. The scanning of the secondary signaler can occur before, after, or simultaneous to the scanning of the primary signaler.

In still another embodiment, when the consumer is provided with the custom packaged product, the consumer is also provided with a coupon. The coupon can include a coupon signaler such as a bar code, a magnetic strip, or a radio frequency identification tag. The coupon signaler can be constructed to convey information about the requested product or about the custom packaged product. For example, in one embodiment of the method of the present invention, a custom packaged product and a coupon are provided to a consumer. The custom packaged product includes a disguising packaging material associated with a product other than the requested product, such as, for example, a popular children's toy. The custom packaged product includes a signaler, such as a secondary signaler, constructed to convey information about the other product. The coupon is constructed to convey information about the requested product. When the secondary signaler is scanned, the information about the other product, such as an identity and price of a popular children's toy, is detected. The detected identity and price of the children's toy can be displayed, such as on an electronic display medium. When the coupon is scanned, the information pertaining to the requested product, such as the identity and price of the requested product, is detected. The detected identity and price information pertaining to the requested product can be displayed, such as on a paper receipt in an inconspicuous manner. In this way, embarrassment to the consumer during the checkout process can be avoided, but true information about the requested product can be provided to the consumer in an inconspicuous fashion.

In certain embodiments, information can be associated with a requested product via pre-programmed instructions, such as in a computer database. For example, in one embodiment, a consumer can indicate in an electronic consumer profile that whenever he or she purchases a particular product, such as a personal absorbent garment, he or she wishes that a displayed description 28, displayed during and/or after checkout, not be associated with the requested product. In a particular embodiment, a scanner 16 senses a primary signaler 30 to determine a requested product's identity, refers to pre-programmed instructions provided by a consumer in the consumer's electronic profile, and retrieves instructions to display a particular description 28, such as a generic description, or a description associated with a product other than the requested product. In other words, sensing the primary signaler invokes information, according to pre-programmed instructions, signaling a discreet status for the requested product. In this way, one of the advantages of the present invention (disguise of a product's true identity) is achieved, without the use of a secondary signaler structure. In such an embodiment, it should be noted that a secondary signaler can be present, but need not be sensed or otherwise used.

In particular embodiments, the method of the present invention includes billing the consumer for the custom packaging product. The billing can occur at a check-out counter 34, pharmacy counter, or other designated location in the store. In certain embodiments, the billing occurs electronically, such as billing a consumer's credit or debit account. The billing can be for the price of the requested product 12, or for some other price, such as an increased price to cover the additional expense of a disguising packaging material 18.

As discussed above, various embodiments of the invention employ the use of radio frequency identification tags. Conventional Radio Frequency Identification (RFID) technology involves the use of radio frequency signals to read information on a small “smart” tag. RFID smart tags, such as primary and secondary signalers 30 and 32, can be “passive” tags that rely on radio frequency energy emitted from a suitable radio frequency emission device 16, commonly called an RFID scanner, to activate a circuit within the tag and provide power to a small antenna. The activated circuit, in turn, generates and transmits a coded response signal to the scanner 16 (or other receiving device) having antenna 22. The coded response signal, which can contain information about the item upon or within which the RFID tag is disposed, is received by the scanner 16 (or other receiving device) and decoded, and information can be displayed to the consumer in a variety of ways as previously discussed.

RFID smart tag technology is known and understood by those skilled in the art, and a detailed explanation thereof is not necessary for purposes of describing the method and system according to the present invention. Generally, conductive or passive smart tags, such as signalers 30 and 32, comprise silicon or other semiconductors, a coiled, etched, or stamped antennae, a capacitor, and a substrate on which the components are mounted or embedded. A protective covering is typically used to encapsulate and seal the substrate. Inductive or passive smart tags have been introduced by Motorola under the name “BiStatix”. A detailed description of the BiStatix device may be found in U.S. Pat. No. 6,259,367 B1, incorporated herein by reference to the extent not inconsistent herewith. Another commercial source of suitable smart tags is Alien Technology Corporation of Morgan Hill, Calif., under the technology name FSA (Fluidic Self-Assembly). With the FSA process, tiny semi-conductor devices are assembled into rolls of flexible plastic. The resulting “smart” substrate can be attached or embedded in a variety of surfaces. The smart tag technology under development at the Auto-ID Center at Massachusetts Institute of Technology (Cambridge, Mass.) can also be used within the scope of the present invention. Further information on smart tags and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega; D. McFarlane, “Auto-ID Based Control,” White Paper for the Auto-ID Centre Institute for Manufacturing, University of Cambridge, Cambridge, United Kingdom, Feb. 1, 2002, available at http://www.autoidlabs.org/whitepapers/CAM-AUTOID-WH-004.pdf;
and Chien Yaw Wong, “Integration of Auto-ID Tagging System with Holonic Manufacturing Systems,” White Paper for the Auto-ID Centre Institute for Manufacturing, University of Cambridge, Cambridge, United Kingdom, September 2001, available at http://www.autoidlabs.org/whitepapers/CAM-WH-001.pdf.

Other RFID technologies believed to be of value for the present invention include those produced by Microchip Technologies (Chandler, Ariz.), which provides remote read-write chips at several frequencies. Also of potential value are the I*CODE chips and readers of Philips Semiconductor (Eindhoven, The Netherlands), which, in one embodiment, are said to include 384 bit configurable read/write memory with 64 bits for a unique serial number (e.g., an electronic product code). Sokymat (Lausanne, Switzerland) markets the PICCOLO read-only RFID disc tag which transmits data to a reader station by an AM radio signal. The tag is said to have 64 bits of data that can be programmed during manufacturer by laser fusing of polysilicon links in order to store a unique code on each tag.

Texas Instruments (Dallas, Tex.) offers RFID technology as part of Texas Instruments RFID (TI*RFID™) Systems, formerly known as the TIRIS© system (Texas Instruments Registration and Identification System), which is used to track and identify various assets using devices such as the TI Tag It™ chip.

Gemplus (Gemenos, France) provides smart tags (sometimes called “smart labels”) and smart cards employing RFID technology, which may be used as smart tags. They also market interfaces, antennas, scanners and software that can be adapted for use with smart tags.

Nedap (Groenlo, The Netherlands) provides smart cards and a 13.56 MHz smart tag using RFID technology with 512 bits of read-write memory with a range of about 120 cm. It is claimed that about 20 such tags per second can be read successfully by a scanner.

Checkpoint Systems Inc. (Miami, Fla.) offers a smart tag with WORM technology (write once, read many). One example is the MCRF355 chip, described more fully at http://www.idsystems.com/reader/1999_{—}05/join0599.htm.

Manufacturing of RFID tags can be done by robotic techniques (e.g., “flip-chip”/“pick and place” techniques), fluidic self-assembly (FSA), the Philips “I-connect” method or the Philips “vibratory assembly” method, the Matrics PICA system (Parallel Integrated Chip Assembly, as described in the news item “New High-Speed RFID Tag Machine,” RFID Journal, Sep. 19, 2003, available online for subscribers at http://www.rfidjournal.com/article/articleview/586/1/1/), or other known processes.

PDA-like reader systems and other portable readers for RFID technology are marketed by Omron Company (Tokyo, Japan), such as the Model V700 or V720 series.

High frequency bands can be used in RFID technology, such as bands between 300 MHz and 10 GHz. SCS Corporation (Rancho Bemardo, Calif.), for example, markets smart tag technology at 2.45 GHz. Ultra-wide band technology can also be adapted for RFID systems.

A related technology within the scope of the present invention is Surface Acoustic Wave (SAW) technology. For example, InfoRay (Cambridge, Mass.) markets a passive smart tag that is said to achieve long ranges (up to 30 meters) using a Surface Acoustic Wave (SAW) device. The SAW device converts a radio signal to an acoustic wave, modulates it with an ID code, then transforms it to another radio signal that is emitted by the smart tag and read by a scanner. The ID code of the smart tag is extracted from the radio signal. The scanner is said to compare the spectral content of the signal with a database of signatures and to derive the ID code. This method enables a read range of up to 30 m. The system can operate in the 915 MHz band and 2.45 GHz band. RFSAW, Inc. (Dallas, Tex.) also provides minute Surface Acoustic Wave (SAW) RFID devices that can be used within the scope of the present invention.

The antennae embedded within the smart tags, such as signalers 30 and 32, are generally one component of the device, though it is recognized that alternatives to antennas may exist in some applications. (For example, for some metallic objects, the smart tag need not comprise an antenna but the metallic object itself can serve as the antenna.) The emitted energy, or excitation signal, from the scanner 16 can be received by the antennae to “activate” the smart tag. The received excitation signal is the power source for the smart tag 30/32 and results in the generation of the electromagnetic responses signal containing the coded information signal. A detailed description of RFID smart tag antennas may be found in U.S. Pat. No. 6,320,556 B1, incorporated herein by reference to the extent not inconsistent herewith.

In an alternate embodiment, the smart tags may be active devices. In this configuration, the smart tag includes active transceiving circuitry that has the capability to selectively respond to coded request signals transmitted by a scanner 16. The active smart tag may include the capability to delete their fixed code and receive new or additional information beyond the information contained in its fixed code. An active smart tag requires an internal power supply, such as a micro-battery, thin film battery, or the like.

The RFID scanner 16 may be of conventional hardware and software architecture. Upon a product being brought into range of the scanner 16, a smart tag, such as signaler 30 or 32, is activated and a coded product information signal is received by the scanner 16 (or other receiving device) and decoded into usable commands or data. The scanner 16 includes a microprocessor and software programs for this purpose.

It is believed that particular embodiments of the method of the present invention can be integrated into the Future Store concept, pioneered by the METRO Group of Dusseldorf, Germany. The Future Store concept is explained at http://www.future-store.org. For example, a “smart shopping cart” as described therein can be used by a consumer to request a product; can present the consumer with a plurality of choices of disguising packaging materials from which to chose; can allow a consumer to select a disguising packaging material from among the plurality of choices; and/or can direct the consumer to a location at which to retrieve his custom packaged product.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. For example, features described in relation to one embodiment may be incorporated into any other embodiment of the invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

1. A method of providing a product to a consumer, comprising:
electronically receiving a request from the consumer to purchase the product;
presenting the consumer with a plurality of choices of disguising packaging materials in which to package the product;
receiving a selection from the consumer for a selected disguising packaging material from among the plurality of choices;
packaging the product with the selected disguising packaging material to create a custom packaged product;
providing the custom packaged product to the consumer; and
billing the consumer for the custom packaged product.

2. The method of claim 1, wherein the product comprises at least one absorbent article adapted to absorb bodily fluids.

3. The method of claim 1, wherein the request is made via an electronic device located within store premises.

4. The method of claim 3, wherein the electronic device is attached to a shopping cart.

5. The method of claim 1, wherein presenting the consumer with a plurality of choices of disguising packaging materials comprises displaying the packaging choices on a computer monitor.

6. The method of claim 5, wherein the computer monitor is located within store premises.

7. The method of claim 1, wherein presenting the consumer with a plurality of choices of disguising packaging materials comprises displaying physical samples of the packaging materials.

8. The method of claim 1, wherein the plurality of choices of disguising packaging materials includes at least one packaging configuration associated with a product other than the requested product.

9. The method of claim 1, wherein the selection is made via an electronic device.

10. The method of claim 9, wherein the electronic device is an interactive computer located within store premises.

11. The method of claim 1, further comprising producing the selected disguising packaging material following the step of receiving a selection, wherein producing the selected disguising packaging material comprises printing graphics on a substrate within store premises.

12. The method of claim 1, further comprising producing the selected disguising packaging material following the step of receiving a selection, wherein producing the selected disguising packaging material comprises adding a barcode associated with the product within store premises.

13. The method of claim 1, wherein packaging the product is conducted at least in part by automated equipment.

14. The method of claim 13, further comprising electronically communicating the received selection to the automated equipment.

15. The method of claim 1, wherein the requested product remains within its original packaging.

16. The method of claim 1, further comprising scanning the custom packaged product to determine an identity and a price of the requested product.

17. The method of claim 16, wherein scanning the custom packaged product causes a description to be displayed on a display medium, the description adapted to conceal the identity of the requested product.

18. The method of claim 17, wherein the display medium is an electronic display medium.

19. The method of claim 17, wherein the display medium is a printed paper receipt.

20. The method of claim 17, wherein the selected disguising packaging material comprises a packaging configuration associated with a product other than the requested product, and the description describes the other product.

21. A method of providing a product to a consumer in which an identity of the product is concealed, comprising:
receiving a request from the consumer to purchase the product;
presenting the consumer with a plurality of choices of disguising packaging materials in which to package the product;
receiving a selection from the consumer for a selected disguising packaging material from among the plurality of choices;
packaging the product with the selected disguising packaging material to create a custom packaged product;
providing the custom packaged product to the consumer;
scanning the custom packaged product to determine the identity and a price of the requested product; and
billing the consumer for the custom packaged product.

22. The method of claim 21, wherein packaging the product comprises disposing a secondary signaler on the custom packaged product, the secondary signaler constructed to convey a discreet status of the requested product.

23. The method of claim 22, wherein the secondary signaler is a printed bar code.

24. The method of claim 22, wherein the secondary signaler is a radio frequency identification device.

25. The method of claim 22, wherein the secondary signaler is constructed to convey the price and the identity of the requested product.

26. The method of claim 22, wherein the requested product includes a primary signaler, the primary signaler constructed to convey the identity and the price of the requested product, the primary signaler comprising a radio frequency identification device.

27. The method of claim 26, wherein scanning the custom packaged product includes scanning the primary signaler to determine the identity and the price of the requested product, and scanning the secondary signaler to determine the discreet status of the requested product.

28. The method of claim 27, wherein scanning the custom packaged product causes a description to be displayed on a display medium, the description adapted to conceal the identity of the requested product.

29. The method of claim 28, wherein the display medium is an electronic display medium.

30. The method of claim 28, wherein the display medium is a printed paper receipt.

31. The method of claim 30, wherein the printed paper receipt further includes a description adapted to reveal the identity of the requested product.

32. The method of claim 21, wherein the plurality of choices of disguising packaging materials includes at least one packaging configuration associated with a product other than the requested product.

33. The method of claim 21, wherein the requested product includes a primary signaler, the primary signaler constructed to convey the identity and the price of the requested product, the primary signaler comprising a radio frequency identification device, wherein scanning the custom packaged product includes scanning the primary signaler to determine the identity and the price of the requested product.

34. The method of claim 33, wherein the primary signaler is further constructed to convey a discreet status of the requested product, and wherein scanning the custom packaged product further includes scanning the primary signaler to determine the discreet status of the requested product.

35. The method of claim 34, wherein scanning the custom packaged product causes a description to be displayed on a display medium, the description adapted to conceal the identity of the requested product.

36. The method of claim 21, wherein the product comprises at least one absorbent article adapted to absorb bodily fluids.

37. A method of providing a product to a consumer in which an identity of the product is concealed, comprising:
receiving a request from the consumer to purchase the product;
presenting the consumer with a plurality of choices of disguising packaging materials in which to package the product;
receiving a selection from the consumer for a selected disguising packaging material from among the plurality of choices;
scanning the requested product to determine the identity and a price of the requested product;
packaging the product with the selected disguising packaging material to create a custom packaged product;
providing the custom packaged product to the consumer;
scanning the custom packaged product to determine the identity, the price, and the discreet status of the requested product; and
billing the consumer for the custom packaged product.

38. The method of claim 37, wherein the requested product includes a primary signaler, the primary signaler constructed to convey the identity and the price of the requested product, the primary signaler comprising a radio frequency identification device.

39. The method of claim 37, wherein the custom packaged product includes a secondary signaler constructed to convey a discreet status of the requested product.

40. The method of claim 39, wherein the secondary signaler is further constructed to convey the identity and the price of the requested product, and scanning the custom packaged product includes scanning the secondary signaler to determine the identity, the price, and the discreet status of the requested product.

41. The method of claim 39, wherein the secondary signaler is a radio frequency identification device.

42. The method of claim 37, wherein scanning the custom packaged product causes a description to be displayed on a display medium, the description adapted to conceal the identity of the requested product.

43. The method of claim 37, where scanning the requested product occurs before packaging the product with the selected disguising packaging material.

44. The method of claim 37, wherein the product comprises at least one absorbent article adapted to absorb bodily fluids.

45. A method of providing a product to a consumer in which an identity of the product is concealed, comprising:
receiving a request from the consumer to purchase the product;
selecting a disguising packaging material for the consumer;
packaging the product with the disguising packaging material to create a custom packaged product;
providing the custom packaged product to the consumer;
scanning the custom packaged product to determine the identity of the requested product; and
billing the consumer for the custom packaged product.

46. The method of claim 45, wherein selecting a disguising packaging material is performed by a computer according to preprogrammed instructions.

47. The method of claim 45, wherein the request is made via an electronic device located within store premises.

48. The method of claim 45, wherein the disguising packaging material is associated with a product other than the requested product.

49. The method of claim 45, wherein the requested product includes a primary signaler, the primary signaler constructed to convey the identity of the requested product, the primary signaler comprising a radio frequency identification device, wherein scanning the custom packaged product includes scanning the primary signaler to determine the identity of the requested product.

50. The method of claim 49, wherein the primary signaler is further constructed to convey a discreet status of the requested product, and wherein scanning the custom packaged product further includes scanning the primary signaler to determine the discreet status of the requested product.
